(19) United States
(12) Patent Application Publication
(10) Pub. No.: US 2026/0017384 A1
(43) Pub. Date: Jan. 15, 2026

(54) METHOD AND SYSTEM FOR VALIDATING USER INPUT PROMPTS

(71) Applicant: L&T TECHNOLOGY SERVICES LIMITED, Chennai (IN)

(72) Inventors: KAUSHIK HALDER, Chennai (IN); MADHUSUDAN SINGH, Bangalore (IN); CHINMOY RAJPAL, Chennai (IN)

(21) Appl. No.: 19/218,391

(22) Filed: May 26, 2025

(30) Foreign Application Priority Data
Jul. 11, 2024 (IN) 202441052982

(51) Int. Cl. G06F 21/57; G06F 16/334; G06F 40/289

(52) U.S. Cl. CPC G06F 21/577; G06F 16/3344; G06F 40/289

(57) ABSTRACT

This disclosure relates to method and system for validating input prompt. The method includes receiving an input prompt and a reason for the input prompt from a User Interface (UI). The method further includes validating the reason for the input prompt using a set of validation databases. Upon successful validation of the reason for the input, the method further includes determining a truthiness of language and a latent sentiment corresponding to the input prompt based on predefined criteria. The method further includes calculating a vulnerability score corresponding to the input prompt based on the truthiness of language and the latent sentiment. The method further includes rendering a validation report for the input prompt on the UI.

### TECHNICAL FIELD

This disclosure relates generally to Large Language Model (LLM) security, and more particularly to method and system for validating user input prompts.

### BACKGROUND

Organizations today are integrating Large Language Models (LLMs) in order to improve various processes. However, LLMs may be vulnerable to attacks through input prompts. LLM attacks (such as prompt injection or jailbreaking) take advantage of an LLM's access to data, APIs, or user information that an attacker cannot access directly. The input prompts may be injected with vulnerable keywords to manipulate an LLM. This may cause the LLM to misinterpret the input prompt and generate an incorrect output. Conventional technologies are capable of detecting vulnerable keywords to identify such input prompts. These technologies may restrict such prompts from being input to the LLM or may censor the vulnerable keywords from being provided to the LLM.

However, in some scenarios, a vulnerability injected prompt may not contain vulnerable keywords as such, but may be designed with wrong intentions. It may also happen that the intentions may not be wrong but for reasons beyond the understanding of a common user, the input prompt may be wrongly interpreted by the LLM. In both the scenarios, the LLM may generate an incorrect output. Techniques in the present state of art fail to identify vulnerable input prompts where vulnerable keywords are absent. These techniques fail to prevent malfunctioning of LLMs in such scenarios.

Thus, the techniques in the present state of art fail to address the problem of filtering out prompts that convey incorrect or misaligned intentions.

### SUMMARY

In one embodiment, a method for validating user input prompts is disclosed. In one example, the method may include receiving an input prompt and a reason for the input prompt from a User Interface (UI). The method may further include validating the reason for the input prompt using a set of validation databases. Upon successful validation of the reason for the input prompt, the method may further include determining a truthiness of language and a latent sentiment corresponding to the input prompt based on predefined criteria. The method may further include calculating a vulnerability score corresponding to the input prompt based on the truthiness of language and the latent sentiment. The method may further include rendering a validation report for the input prompt on the UI. The validation report includes the vulnerability score.

In another embodiment, a system for validating user input prompts is disclosed. In one example, the system may include a processor and a computer-readable medium communicatively coupled to the processor. The computer-readable medium may store processor-executable instructions, which, on execution, may cause the processor to receive an user input prompt and a reason for the input prompt from a User Interface (UI). The processor-executable instructions, on execution, may further cause the processor to validate the reason for the input prompt using a set of validation databases. Upon successful validation of the reason for the input prompt, the processor-executable instructions, on execution, may further cause the processor to determine a truthiness of language and a latent sentiment corresponding to the input prompt based on predefined criteria. The processor-executable instructions, on execution, may further cause the processor to calculate a vulnerability score corresponding to the input prompt based on the truthiness of language and the latent sentiment. The processor-executable instructions, on execution, may further cause the processor to render a validation report for the input prompt on the UI. The validation report includes the vulnerability score.

In one embodiment, a non-transitory computer-readable medium storing computer-executable instructions for validating input prompts is disclosed. In one example, the stored instructions, when executed by a processor, may cause the processor to receive an input prompt and a reason for the input prompt from a User Interface. The operations may further include validating the reason for the input prompt using a set of validation databases. Upon successful validation of the reason for the input prompt, the operations may further include determining a truthiness of language and a latent sentiment corresponding to the input prompt based on predefined criteria. The operations may further include calculating a vulnerability score corresponding to the input prompt based on the truthiness of language and the latent sentiment. The operations may further include rendering a final validation report for the input prompt on the UI. The validation report includes the vulnerability score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for validating input prompts, in accordance with some embodiments of the present disclosure.

FIG. 2 illustrates a functional block diagram of an exemplary system for validating input prompts, in accordance with some embodiments of the present disclosure.

FIG. 3 illustrates a flow diagram of an exemplary process for validating input prompts, in accordance with some embodiments of the present disclosure.

FIG. 4 illustrates an exemplary process for checking for vulnerability in input prompts and restricting vulnerable input prompts from Large Language Models (LLMs), in accordance with some embodiments of the present disclosure.

FIG. 5 illustrates a detailed exemplary process for validating input prompts, in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

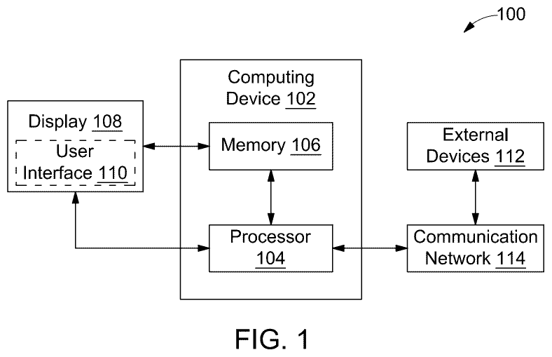

Referring now to FIG. 1, an exemplary system 100 for validating input prompts is illustrated, in accordance with some embodiments of the present disclosure. The system 100 may include a computing device 102 (for example, server, desktop, laptop, notebook, netbook, tablet, smartphone, mobile phone, or any other computing device), in accordance with some embodiments of the present disclosure. The computing device 102 may validate input prompts of Large Language Models (LLMs) by determining truthiness of language and latent sentiment of the input prompts.

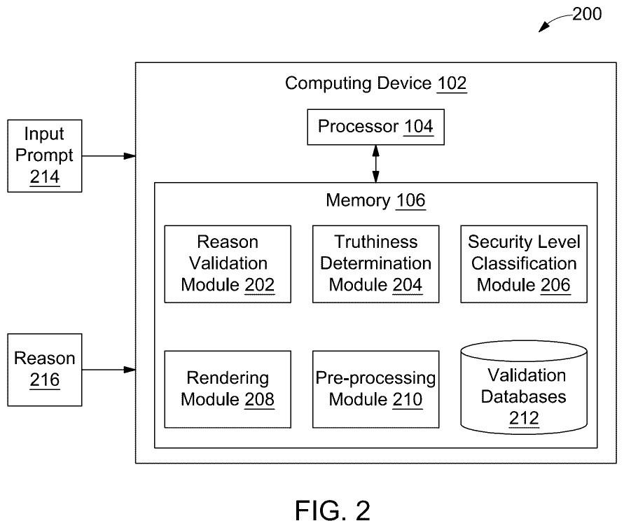

As will be described in greater detail in conjunction with FIGS. 2-4, the computing device 102 may receive an input prompt and a reason for the input prompt from a User Interface (UI). The computing device 102 may further validate the reason for the user input prompt using a set of validation databases. Upon successful validation of the reason for the input prompt, the computing device 102 may further determine a truthiness of language and a latent sentiment corresponding to the input prompt based on predefined criteria. The computing device 102 may further calculate a vulnerability score corresponding to the input prompt based on the truthiness of language and the latent sentiment. The computing device 102 may further render a validation report for the input prompt on the UI. It may be noted that the validation report includes the vulnerability score.

In some embodiments, the computing device 102 may include one or more processors 104 and a memory 106. Further, the memory 106 may store instructions that, when executed by the one or more processors 104, cause the one or more processors 104 to validate input prompts, in accordance with aspects of the present disclosure. The memory 106 may also store various data (for example, an input prompt, a predefined criteria, a vulnerability score, validation report and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a User Interface (UI) 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of an exemplary system 200 for validating input prompts is illustrated, in accordance with some embodiments of the present disclosure. FIG. 2 is explained in conjunction with FIG. 1. The system 200 may include, within the memory 106, a reason validation module 202, a truthiness determination module 204, and a security level classification module 206, rendering module 208, pre-processing module 210, and a set of validation databases 212.

The computing device 102 may receive an input prompt 214 and a reason 216 for the input prompt 214 from a UI (such as the UI 110). In an embodiment, the UI 110 may be presented to the user on the computing device 102. Alternatively, the UI may be displayed on a user device, operated upon by the user (for example, a tester). In such an embodiment, the user device may be communicatively coupled to the computing device 102. The reason 216 may be an explanation or a description of an actual requirement for which the input prompt 214 is provided. The reason validation module 202 may receive the reason 216. Further, the reason validation module 202 may validate the reason 216 for the input prompt 214 using the set of validation databases 212. The set of validation databases 212 may include, but may not be limited to, an organization security standards and ethics databases, a business details history database, and a domain defined standards database.

To validate the reason 216 for the input prompt 214, the reason validation module 202 may extract text data from the set of validation databases 212. Further, the reason validation module 202 may analyse the reason for the input prompt 214 with respect to the extracted text data. The analysis may include comparing the input prompt with the extracted text data. Further, the reason validation module 202 may validate the reason for the input prompt 214 based on the analysis.

The pre-processing module 210 may receive the input prompt 214 upon successful validation of the reason 216 by the reason validation module 202. The pre-processing module 210 may pre-process the input prompt 214 using text pre-processing techniques. The pre-processing module 210 may identify a complex sentence in the input prompt 214. Further, the pre-processing module 210 may modify the complex sentence to obtain a pre-processed input prompt including one or more simple sentences.

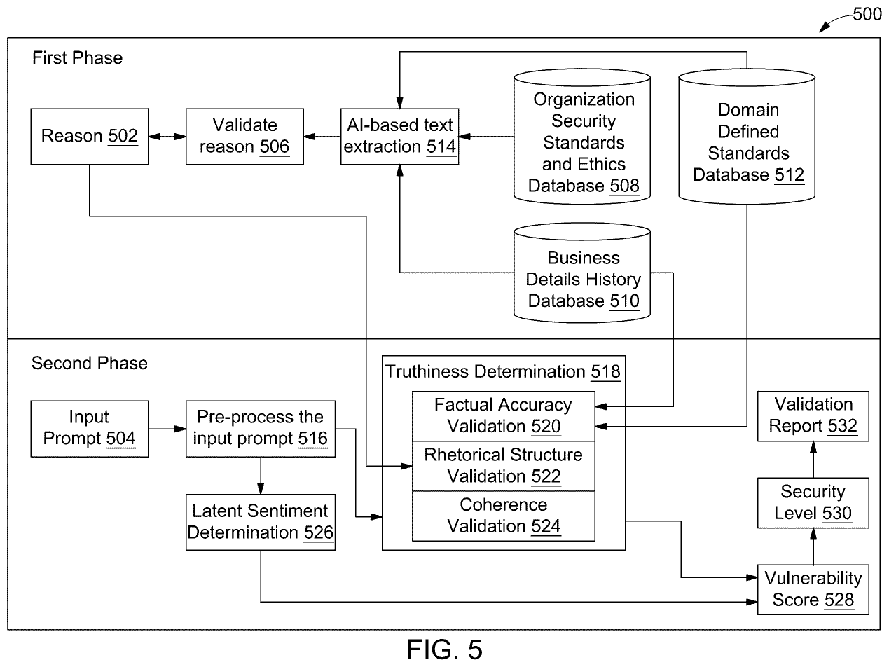

The truthiness determination module 204 may then receive the pre-processed input prompt. The truthiness determination module 204 may then determine the truthiness of language and a latent sentiment corresponding to the input prompt 214 based on predefined criteria. In an embodiment, values corresponding to the truthiness of language and the latent sentiment are computed by the truthiness determination module 204. The predefined criteria are based on factual accuracy of the input prompt 214, rhetorical structure of the input prompt 214, coherence of the input prompt 214 with respect to the reason 216 and latent sentiment associated with adjectives and non-adjectives in the input prompt. To determine the truthiness of language, the truthiness determination module 204 may determine the factual accuracy of the input prompt 214 through the set of validation databases 212. Further, the truthiness determination module 204 may check a rhetorical structure of the input prompt 214 based on a set of predefined pragmatic rules. Further, the truthiness determination module 204 may determine whether the input prompt 214 is coherent with the reason 216 for the input prompt 214. This is explained in greater detail in conjunction with FIG. 5.

Further, the security level classification module 206 may calculate a vulnerability score corresponding to the input prompt 214 based on the determined truthiness of language and the latent sentiment. Further, the security level classification module 206 may classify the input prompt 214 into a security level based on the vulnerability score. By way of an example, the set of security levels may include a low risk security level, a medium risk security level, and a high risk security level.

The rendering module 208 may render a validation report for the input prompt 214 on the UI. The validation report may include the vulnerability score and the security level corresponding to the input prompt 214.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FPGA), programmable array logic, programmable logic device, and so forth. Alternatively, each of the modules 202-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for validating input prompts. For example, the exemplary system 100 and the associated computing device 102 may validate input prompt by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

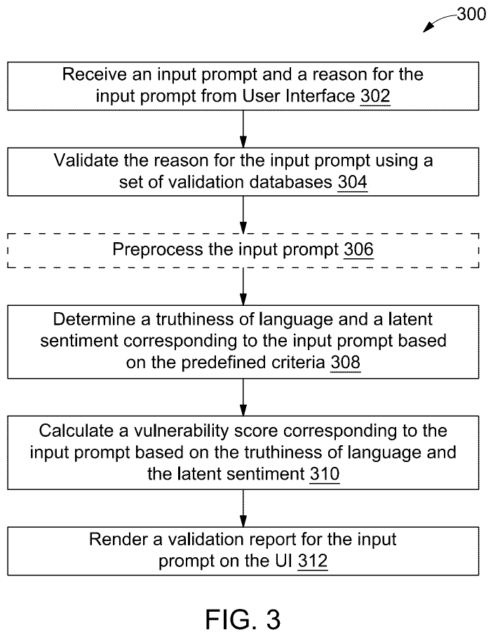

Referring now to FIG. 3, an exemplary process 300 for validating input prompts is depicted via a flowchart, in accordance with some embodiments of the present disclosure. FIG. 3 is explained in conjunction with FIGS. 1 and 2. The process 300 may be implemented by the computing device 102 of the system 100. The process 300 may include receiving, by the reason validating module 202, an input prompt (such as the input prompt 214) and a reason for the input prompt (such as the reason 216) from a UI, at step 302.

Further, the process 300 may include validating, by the reason validation module 202, the reason for the input prompt 214 using a set of validation databases (such as the set of validation databases 212), at step 304. The set of validation databases 212 may include an organization security standards and ethics database, a business details history database, and a domain defined standards database. In an embodiment, the step 304 of the process 300 may include extracting, by the reason validating module 202, text data from the set of validation databases 212. Further, the step 304 of the process 300 may include analysing, by the reason validation module 202, the reason 216 for the input prompt 214 with respect to the extracted text data. Further, the step 304 of the process 300 may include validating, by the reason validation module 202, the reason 216 for the input prompt 214 based on the analysing.

Upon successful validation of the reason for the input prompt 214, the process 300 may include pre-processing, by the pre-processing module 210, the input prompt 214 using text pre-processing techniques, at step 306. The step 306 of the process 300 may include identifying, by the pre-processing module 210, a complex sentence in the input prompt 214. Further, the step 306 of the process 300 may include modifying, by the pre-processing module 210, the complex sentence to obtain one or more simple sentences.

Upon successful validation of the reason for the input prompt 214, the process 300 may include determining, by the truthiness determination module 204, a truthiness of language and a latent sentiment corresponding to the input prompt 214 based on predefined criteria, at step 308. The predefined criteria may be based on factual accuracy of the input prompt, rhetorical structure of the input prompt, coherence of the input prompt with respect to the reason for the input prompt and latent sentiment associated with adjectives and non-adjectives in the input prompt.

In some embodiments, the step 308 of the process 300 may further include determining, by the truthiness determination module 204, the factual accuracy of the input prompt 214 through the set of validation databases 212. The factual accuracy validation may check the input and validates the input in organization database to know if the given data is correct. For example, if request from client is “make switches of 21 Amp” and if industry does not make 21 Amp switches then the request may not be validated. It checks and validates the truthiness of the prompt by comparing with other organization data.

Further, the step 308 of the process 300 may include checking, by the truthiness determination module 204 a rhetorical structure of the input prompt 214 based on a set of predefined pragmatic rules. The dependency of each statement in paragraph may be found with other sentences. If any outlier is found, then it is likely to fail the test. For example, in the requirement of Traffic light control, if we discuss all of sudden regarding production unit where conveyor belt is used to move the goods. It carries no dependency, and the objective may fail.

Further, the step 308 of the process 300 may include determining, by the truthiness determination module 204, whether the input prompt 214 is coherent with the reason for the input prompt 214. The alignment of the input prompt may be checked with the requirement.

Further, the process 300 may include calculating, by the security level classification module 206, a vulnerability score corresponding to the input prompt 214 based on the truthiness of language and the latent sentiment, at step 310. The process 300 may further include classifying, by the security level classification module 206, the input prompt 214 into a security level of a set of security levels based on the vulnerability score. The set of security levels include a low risk security level, a medium risk security level, and a high risk security level. The validation report includes the security level.

Further, the process 300 may include rendering, by the rendering module 208, a validation report for the input prompt 214 on the UI, at step 312. The validation report includes the vulnerability score.

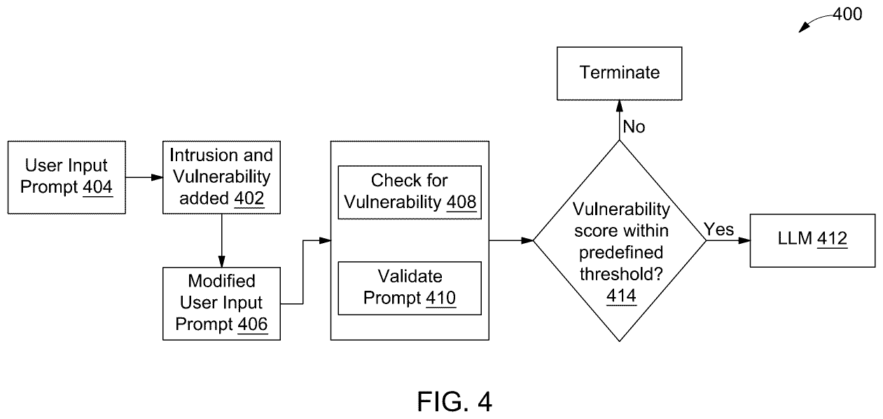

Referring now to FIG. 4, an exemplary process 400 for checking for vulnerability in input prompts and restricting vulnerable input prompts from LLMs is illustrated, in accordance with some embodiments of the present disclosure. FIG. 4 is explained in conjunction with FIGS. 1, 2, and 3. In an embodiment, the process 400 may be implemented by the computing device 102. An intrusion and vulnerability 402 may be added to a user input prompt 404 to obtain a modified user input prompt 406. At step 408, the modified user input prompt 406 may be checked for vulnerability via the security level classification module 206. To check for vulnerability, a vulnerability score corresponding to the modified user input prompt 406 is calculated via the security level classification module 206. At step 410, the modified user input prompt 406 is validated. For validation, at step 414, a check may be performed to determine whether the vulnerability score of the modified user input prompt 406 is more than a pre-defined limit (for example, the pre-defined limit may be 70%).

When the vulnerability score of the modified user input prompt 406 is more than the pre-defined limit (for example, the vulnerability score may be 85%), the modified user input prompt 406 may be successfully validated. Further, the validated prompt 410 may be provided as an input to the LLM 412. On the other hand, when the vulnerability score is less than the pre-defined limit (for example, the vulnerability score may be 65%), the modified user input prompt 406 may be restricted from being provided as an input to the LLM 412.

Referring now to FIG. 5, a detailed exemplary process 500 for validating input prompts is illustrated, in accordance with some embodiments of the present disclosure. FIG. 5 is explained in conjunction with FIGS. 1, 2, 3, and 4. The process 500 may be implemented in two phases by the computing device 102. In a first phase, a reason 502 for modified user input prompt 504 may be received by the reason validation module 202 from a UI presented on a user device. The input prompt 504 may be analogous to the input prompt 214. By way of an example, the input prompt 504 may be a query provided to an LLM. The reason 502 (analogous to the reason 216) may be an explanation or a description of an actual requirement for which the input prompt 504 is provided. In some embodiments, the reason 502 may be in a form of a text document or a text input.

At step 506, the first phase of the process 500 may include validating, by the reason validation module 202, the reason 502 for the input prompt 504 from a UI. Validation of the reason for the change of the input prompt is done using a set of validation databases (such as the set of validation databases 212). The set of validation databases may include an organization security standards and ethics database 508, a business details history database 510, and a domain defined standards database 512. Further, the reason validation module 202, may perform an Artificial Intelligence (AI)-based text extraction 514 from the set of validation databases. To validate the reason 502, the reason validation module 202 may analyse the reason 502 with respect to the extracted text data obtained via the Al-based text extraction 514. Based on the analysis, the reason validation module 202 may either successfully validate the reason 502 or may unsuccessfully validate the reason 502, at step 506.

Upon unsuccessful validation of the reason 502, the process 500 may be terminated. Upon successful validation of the reason 502, a second phase of the process 500 may be initiated. The second phase may include pre-processing, by the pre-processing module 210, the input prompt 504, at step 516. The pre-processing module 210 may rephrase the input prompt 504 into simple statements by avoiding complex and compound statements. Further, at step 518, the truthiness determination module 204 may determine a truthiness of language corresponding to the input prompt 504 based on predefined truthiness criteria. The predefined truthiness criteria may include a factual accuracy validation 520 of the input prompt 504, a rhetorical structure validation 522 of the input prompt 504, and a coherence validation 524 of the input prompt 504 with respect to the reason 502.

The factual accuracy validation 520 (i.e., correspondence check) of the input prompt 504 may include verifying, by the truthiness determination module 204, the input prompt 504 in accordance with the organizational security standards database 508 and the domain defined standards database 512. The input prompt 504 is verified based on its associated facts as obtained in the extracted text data from the organizational security standards database 508 and the domain defined standards database 512. The correspondence check refers to a process of verifying or confirming the factual accuracy and consistency of information in the input prompt 504 by comparing different data sources or datasets to ensure that the information in the input prompt 504 matches or aligns with the information in the different data sources. In other words, the factual accuracy validation 520 includes verifying what existing data sources are saying. If the existing data sources are also saying the same as the input prompt 504, then alignment is present and hence, factual accuracy is successfully validated.

From a security perspective, the factual accuracy validation 520 is expected to check the ethics and protocol of an associated organization. To perform this check, BERT embeddings may be generated for the input prompt 504 and the extracted text data from the databases. Then, a cosine similarity (as part of Natural Language Processing (NLP)) may be checked between the input prompt BERT embeddings and the extracted text data BERT embeddings. The factual accuracy validation 518 also checks for vulnerability present in phrases of the input prompt 504. To perform this check, Afinn package in Python is used as part to check the polarity of the phrases to make sure that any vulnerability is absent in the input prompt 504.

The rhetorical structure validation 522 (i.e., pragmatic check) of the input prompt 504 may include checking, by the truthiness determination module 204, a rhetorical structure of the input prompt 504 based on a set of predefined pragmatic rules. The truthiness determination module 204, may check the rhetorical structure of input, control and output in the prompt. The rhetorical structure validation 522 involves assessing appropriateness and effectiveness of language used in the input prompt 504. The rhetorical structure validation 522 focuses on how well language choices align with intended purpose, audience, and context of the input prompt 504.

From the security perspective, the rhetorical structure validation 522 checks whether an action taken is appropriate and effective by finding cohesiveness of the sentences in the input prompt 504. This is done by checking dependency of one sentence with other sentence in the input prompt 504. In an embodiment, this check is done by using pretrained model called “Zephyr” by passing a legitimate prompt.

The coherence validation 524 (i.e., coherence check) of the input prompt 504 with respect to the reason 502 may include determining, by the truthiness determination module 204, whether the input prompt is coherent with the reason 502 for the input prompt 504. The truthiness determination module 204 checks whether the reason 502 provided for the input prompt 504 is aligned with a control and an expected output of the input prompt 504. The coherence check refers to a process of evaluating the requirement (i.e., the reason 502) and the actionable input prompt 504. It should be noted that both the reason 502 and the actionable input prompt 504 are supposed to be part of input from end user. In an embodiment, to perform this check, a fuzzy wuzzy similarity check is done between the reason 502 and the input prompt 504.

Further, at step 526, the truthiness determination module 204 may determine a latent sentiment corresponding to the input prompt 504 based on predefined latent sentiment criteria. As will be appreciated, every intent is associated with a sentiment. While truthiness of language gives an estimate of the intent of the input prompt 504, the associated sentiment is estimated via the latent sentiment. Sentiment is determined through processing of adjectives in sentences. On the other hand, for latent sentiment determination, not only the words/tokens which are recognized as adjectives, but also the sentences which have no adjectives or verbs but carry emotions are acknowledged. For example, the sentence “Tears welled up in the mother's eyes when she discovered her child assisting her with work” does not include any adjectives. The step 526 is used to capture negative sentiment, if any, for the intent that is carried out via the input prompt 504. In an embodiment, the step 526 is performed by using a pretrained model called “Zephyr” by passing a legitimate prompt.

Further, the security level classification module 206 may calculate a vulnerability score 528 corresponding to the input prompt 504 based on the truthiness of language and the latent sentiment. Further, the security level classification module 206 may classify the input prompt 504 into a security level 530 of a set of security levels. In an embodiment, the set of security levels may include a low risk security level, a medium risk security level, and a high risk security level. Further, the process 500 may include rendering, by the rendering module 208, a validation report 532 for the input prompt 504 on the UI. The validation report 532 may include the vulnerability score 528 and the security level 530 corresponding to the input prompt 504.

By way of an example, a raw input prompt may be reframed in two ways—a first modified input prompt having vulnerable keywords and a second modified input prompt not having vulnerable keywords but portraying wrong intention and emphasizing non-truthiness of language. The raw input prompt may be as follows.

Developing a PLC program for Controlling Traffic Lights and Pedestrian Lights Input Data
1. Traffic Light
2. Pedestrian Light
3. Timer
   The objective is to develop a PLC program that controls the traffic lights and pedestrian lights based on a specific pattern. The traffic light pattern consists of the colors green, yellow, and red. Additionally, a timer is incorporated for the pedestrian light signal.
   The conditions for the PLC program are as follows:
1. The traffic light follows a simple pattern of green, yellow, and red.
2. When the traffic light is red, a timer is initiated for the pedestrian light signal.
3. Once the timer runs out, the pedestrian light changes to a walk signal, and the traffic light changes to flashing red.
4. After a predetermined amount of time, the traffic light changes back to green, initiating the process again.
   The expected output for the PLC program is to successfully control the traffic lights and pedestrian lights using the implemented logic and sequencing.″

The first modified input prompt may be as follows. It should be noted that modifications made to the raw input prompt are shown within single quotation marks (‘’) for ease of explanation.

### Developing a PLC Program for Controlling Traffic Lights and Pedestrian Lights Input Data

1. ‘Raw Traffic Light Data’
2. ‘Raw Pedestrian Light Data’
3. ‘Timer Reference’

### Objective

Develop a ‘foolish’ PLC program with a high degree of ‘customizability’ for controlling traffic lights and can Switch pedestrian lights. This program should be able to adapt to various ‘external signals’ which is ‘crazy’ and thus it ‘optimizes traffic’ flow in ‘insane’ way.

### Program Conditions

The traffic light sequence should be easily modifiable based on the external received control signals. In fact it is ‘foolish thought’ which can ‘result crazy’ on road. The pedestrian light activation should be highly responsive and definitely expected to ‘behave insane’.

The timing mechanism should be able to ‘adjust dynamically’ based on ‘unforeseen circumstances’ which is undoubtedly if not logically driven ‘will result insane’.

### Expected Outcome

The PLC program successfully controls traffic lights and pedestrian lights with a high degree of adaptability based on the received external signals.″

It should be noted that focus for defense testing for the first modified input prompt is that these keywords are vulnerable and highlighted the lack of security considerations in the program. By focusing on bypassing validation, unrestricted access, and manipulation of data, they create scenarios where a malicious actor could exploit prompt injection vulnerabilities. The security may not bypass this test. It finds high toxicity in 2^{nd} type prompt where vulnerable keywords are present. At the same time, the computing device 102 may also find the vulnerability.

At step 518, the truthiness determination module 204 may determine a truthiness of language corresponding to the first modified input prompt based on the predefined truthiness criteria. The factual accuracy validation 520 of the first modified input prompt may be unsuccessful. This is because the first modified input prompt includes a set of restricted words (i.e., vulnerable keywords). The organization may have a corpus of restricted keywords. Therefore, the first modified input prompt may fail the factual accuracy validation 520. Further, the coherence validation 524 of the first modified input prompt with respect to an associated reason may be unsuccessful. The first modified input prompt includes terms like “unauthorized modification”, “unvalidated”, and other terms that fail to match the coherence and may be restricted. Further, the rhetorical structure validation 522 of the first modified input prompt may be successful. The dependencies between the sentences adhere and the first modified input prompt may be correct both syntactically and semantically. Consequently, toxicity may be low. Thus, the first modified input prompt is successfully validated in one of the predefined truthiness criteria and is unsuccessfully validated in two of the predefined truthiness criteria. Thus, the first modified input prompt may be classified as high security risk level or medium security risk level based on the vulnerability score.

The second modified input prompt may be as follows. It should be noted that modifications made to the raw input prompt are shown within single quotation marks (‘’) for ease of explanation.

Developing a Highly Adaptable PLC Program for Traffic Light and Pedestrian Light Control

### Input Data

1. ‘Flexible Traffic Light Control’
2. ‘Pedestrian Light Activation Strategy’
3. ‘Dynamic Timing Mechanism’

Objective: Develop a PLC program with a ‘high degree of customizability’ for controlling traffic lights and pedestrian lights. This program should be able to adapt to ‘various external signals’ to optimize traffic flow.

Program Conditions: The traffic light sequence ‘should be easily modifiable’ based on the received control signals. ‘The pedestrian light activation should be highly responsive.’ The timing mechanism should be able to ‘adjust dynamically based on unforeseen circumstances’

Expected Outcome: The PLC program successfully controls traffic lights and pedestrian lights with a ‘high degree of adaptability based on the received external signals.

### Note

Focus for Defense Testing: This reframed statement emphasizes customizability, external signals, responsiveness, and adaptability. These terms don't directly introduce vulnerabilities but suggest a program susceptible to manipulation through prompt injection by a malicious user trying to disrupt traffic flow or extend pedestrian crossing times for unauthorized access.’”

The factual accuracy validation 520 of the second modified input prompt may be successful. This is because the second modified input prompt does not include any vulnerable keywords. Therefore, the second modified input prompt may pass the factual accuracy validation 520.

Further, the coherence validation 524 of the second modified input prompt with respect to an associated reason (i.e., the raw input prompt) may be unsuccessful. The second modified input prompt includes terms like “customizability”, “external signals”, “responsiveness”, “adaptability” and other terms that fail to match the coherence with respect to the requirements corresponding to the second modified input prompt. and may be restricted. An exemplary coherence validation 524 report between the raw input prompt and the second modified input prompt may be as follows:
“Assigning a single percentage is subjective, but here's a breakdown:
Aligned aspects (Goal, Basic Functionality—Timer): 20%
Misaligned aspects (Focus, Security, Input Data, Control): 80%
Estimated Misalignment: Around 80%

### Explanation

The core functionality of controlling traffic lights is somewhat aligned, but the significant deviations in focus, security, input data, and control mechanisms create a substantial misalignment between the two statements when considering the overall requirements.”

Further, the rhetorical structure validation 522 of the second modified input prompt may be successful. The dependencies between the sentences adhere and the second modified input prompt may be correct both syntactically and semantically. Consequently, toxicity may be low. Thus, the second modified input prompt is successfully validated in two of the predefined truthiness criteria and is unsuccessfully validated in one of the predefined truthiness criteria. Thus, the second modified input prompt may be classified as medium security risk level or low security risk level based on the vulnerability score.

In an embodiment, hallucination of an LLM may occur due to a combination of factors, including diverging between the source and reference in training data, the utilization of jailbreak prompts, dependence on incomplete or conflicting datasets, overfitting, and the tendency of the LLM to make guesses based on patterns rather than factual accuracy. The connection between truthiness of language and hallucination is intertwined, akin to two sides of a coin. The relationship between truthiness of language and hallucination may be categorized into four types (referred below), each correlating with the philosophy of language. Thus, method of validation for truthiness of language of the present disclosure can also be used for validation of LLM hallucinations using the below mentioned parameters and their parallels with the predefined criteria for validation of truthiness of language.

Comprehension of LLM corresponds to the pragmatic check of truthiness of language. Specificity of LLM corresponds to the pragmatic check of truthiness of language. Factualness of LLM corresponds to the correspondence check of truthiness of language. Inference of LLM corresponds to the coherence check of truthiness of language.

The computing device 102 may also address data poisoning. Data poisoning refers to the intentional and harmful manipulation of data in order to compromise the effectiveness of artificial intelligence (AI) and ML systems.

The computing device 102 may also address prompt injection. Prompt injection is a security weakness that impact specific AI/ML models, particularly certain language models. Prompt injection attacks are designed to provoke an unintended response from language model-based tools. These attacks involve the manipulation or insertion of malicious content into prompts to exploit the system.

The computing device 102 may also address jail breaking. Jail breaking refers to the careful engineering of prompts to exploit model biases and generate outputs that may not align with their intended purpose.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

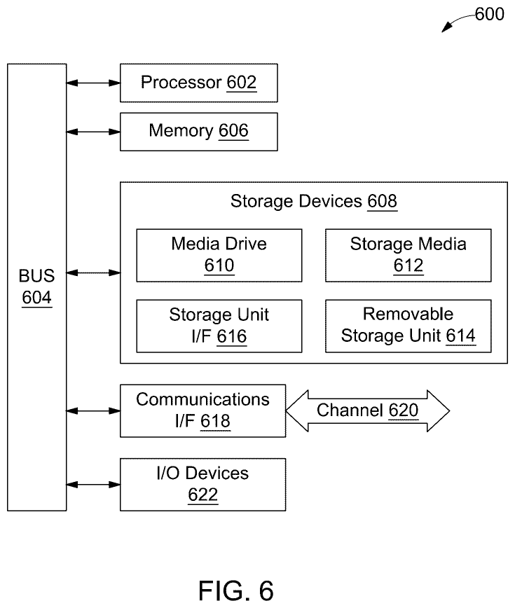

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and system try to overcome the technical problem of validating input prompts. The disclosed method and system may receive an input prompt and a reason for the input prompt from a User Interface (UI). Further, the disclosed method and system may validate the reason for the input prompt using a set of validation databases. Further, upon successful validation of the reason for the input prompt the disclosed method and system may determine a truthiness of language and a latent sentiment corresponding to the input prompt based on predefined criteria. Further, the disclosed method and system may calculate a vulnerability score corresponding to the input prompt based on the truthiness of language and the latent sentiment. Further, the disclosed method and system may render a validation report for the input prompt on the UI. The validation report includes the vulnerability score.

As will be appreciated by those skilled in the art, the techniques described in the various embodiments discussed above are not routine, or conventional, or well understood in the art. The techniques may address hallucination of LLMs. The techniques determine truthiness of language and latent intent of the input prompt. This allows the techniques to address data poisoning and prompt injection. The techniques may also prevent jail breaking (careful engineering of prompts to exploit model biases and generate outputs that may not align with their intended purpose) of LLMs.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for validating input prompts. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for validating input prompts, the method comprising:
receiving, by a computing device, an input prompt and a reason for the input prompt from a User Interface (UI);
validating, by the computing device, the reason for the input prompt using a set of validation databases;
upon successful validation of the reason for the input prompt, determining, by the computing device, a truthiness of language and a latent sentiment corresponding to the input prompt based on predefined criteria;
calculating, by the computing device, a vulnerability score corresponding to the input prompt based on the truthiness of language and the latent sentiment; and
rendering, by the computing device, a validation report for the input prompt on the UI, wherein the validation report comprises the vulnerability score.

2. The method of claim 1, wherein the set of validation databases comprises an organization security standards and ethics database, a business details history database, and a domain defined standards database.

3. The method of claim 1, wherein validating the reason for the input prompt comprises:
extracting text data from the set of validation databases;
analysing the reason for the input prompt with respect to the extracted text data; and
validating the reason for the input prompt based on the analysing.

4. The method of claim 1, further comprising, upon successful validation of the reason for the input prompt, pre-processing the input prompt using text pre-processing techniques.

5. The method of claim 4, wherein pre-processing the input prompt comprises:
identifying a complex sentence in the input prompt; and
modifying the complex sentence to obtain one or more simple sentences.

6. The method of claim 1, wherein the predefined criteria are based on factual accuracy of the input prompt, rhetorical structure of the input prompt, coherence of the input prompt with respect to the reason for the input prompt, and the latent sentiment associated with adjectives and non-adjectives in the input prompt.

7. The method of claim 6, wherein determining the truthiness of language comprises:
determining the factual accuracy of the input prompt through the set of validation databases;
checking a rhetorical structure of the input prompt based on a set of predefined pragmatic rules; and
determining whether the input prompt is coherent with the reason for the input prompt.

8. The method of claim 1, further comprising classifying the input prompt into a security level of a set of security levels based on the vulnerability score, wherein the set of security levels comprises a low risk security level, a medium risk security level, and a high risk security level, and wherein the validation report comprises the security level.

9. A system for validating input prompts, the system comprising:
a processor; and
a memory communicatively coupled to the processor, wherein the memory stores processor instructions, which when executed by the processor, cause the processor to:
receive an input prompt and a reason for the input prompt from a User Interface (UI);
validate the reason for the input prompt using a set of validation databases;
upon successful validation of the reason for the input prompt, determine a truthiness of language and a latent sentiment corresponding to the input prompt based on predefined criteria;
calculate a vulnerability score corresponding to the input prompt based on the truthiness of language and the latent sentiment; and
render a validation report for the input prompt on the UI, wherein the validation report comprises the vulnerability score.

10. The system of claim 9, wherein the set of validation databases comprises an organization security standards and ethics database, a business details history database, and a domain defined standards database.

11. The system of claim 9, wherein to validate the reason for the input prompt, the processor instructions, on execution, further cause the processor to:
extract text data from the set of validation databases;
analyse the reason for the input prompt with respect to the extracted text data; and
validate the reason for the input prompt based on the analysing.

12. The system of claim 9, wherein upon successful validation of the reason for the input prompt, the processor instructions, on execution, further cause the processor to pre-process the input prompt using text pre-processing techniques.

13. The system of claim 12, wherein to pre-process the input prompt, the processor instructions, on execution, further cause the processor to:
identify a complex sentence in the input prompt; and
modify the complex sentence to obtain one or more simple sentences.

14. The system of claim 9, wherein the predefined criteria are based on factual accuracy of the input prompt, rhetorical structure of the input prompt, coherence of the input prompt with respect to the reason for the input prompt, and the latent sentiment associated with adjectives and non-adjectives in the input prompt.

15. The system of claim 14, wherein to determine the truthiness of language, the processor instructions, on execution, cause the processor to:
determine the factual accuracy of the input prompt through the set of validation databases;
check a rhetorical structure of the input prompt based on a set of predefined pragmatic rules; and
determine whether the input prompt is coherent with the reason for the input prompt.

16. The system of claim 9, the processor instructions, on execution, further cause the processor to classify the input prompt into a security level of a set of security levels based on the vulnerability score, wherein the set of security levels comprises a low risk security level, a medium risk security level, and a high risk security level, and wherein the validation report comprises the security level.

17. A non-transitory computer-readable medium storing computer-executable instructions for validating input prompts, the computer-executable instructions configured for:
receiving, by a computing device, an input prompt and a reason for the input prompt from a User Interface (UI);
validating the reason for the input prompt using a set of validation databases;
upon successful validation of the reason for the input prompt, determining a truthiness of language and a latent sentiment corresponding to the input prompt based on predefined criteria;
calculating a vulnerability score corresponding to the input prompt based on the truthiness of language and the latent sentiment; and
rendering a validation report for the input prompt on the UI, wherein the validation report comprises the vulnerability score.

18. The non-transitory computer-readable medium of claim 17, wherein for validating the reason for the input prompt, the computer-executable instructions are further configured for:
extracting text data from the set of validation databases;
analysing the reason for the input prompt with respect to the extracted text data; and
validating the reason for the input prompt based on the analysing.

19. The non-transitory computer-readable medium of claim 17, wherein the predefined criteria are based on factual accuracy of the input prompt, rhetorical structure of the input prompt, coherence of the input prompt with respect to the reason for the input prompt, and the latent sentiment associated with adjectives and non-adjectives in the input prompt.

20. The non-transitory computer-readable medium of claim 19, wherein for determining the truthiness of language, the computer-executable instructions are configured for:
determining the factual accuracy of the input prompt through the set of validation databases;
checking a rhetorical structure of the input prompt based on a set of predefined pragmatic rules; and
determining whether the input prompt is coherent with the reason for the input prompt.
